(19) United States
(12) Patent Application Publication
(10) Pub. No.: US 2022/0036216 A1
(43) Pub. Date: Feb. 3, 2022

(54) Predicted Variables in Programming

(71) Applicant: Google LLC, Mountain View, CA (US)

(72) Inventors: Jay Yagnik, Mountain View, CA (US); Aleksandr Darin, Adliswil (CH); Thierry Coppey, Thalwil (CH); Thomas Deselaers, Zurich (CH); Victor Carbune, Zurich (CH)

(21) Appl. No.: 17/280,034

(22) PCT Filed: Nov. 20, 2018
(86) PCT No.: PCT/US2018/062050

§ 371 Date: Mar. 25, 2021

Related U.S. Application Data
(60) Provisional application No. 62/737,048, filed on Sep. 26, 2018.

(51) Int. Cl. G06N 5/04; G06N 20/00

(52) U.S. Cl. CPC G06N 5/04; G06N 20/00

(57) ABSTRACT

The present disclosure is directed to a new framework the enables the combination of symbolic programming with machine learning, where the programmer maintains control of the overall architecture of the functional mapping and the ability to inject domain knowledge while allowing their program to evolve by learning from examples. In some instances, the framework provided herein can be referred to as “predictive programming.”

### FIELD

The present disclosure relates generally to the intersection of machine learning and computer programming. More particularly, the present disclosure relates to use of a machine learning system to predict a variable defined within a computer program.

### BACKGROUND

Machine learning as a field has experienced a steep rate of progress in the past decade, both in terms of the techniques and systems as well as in terms of the growing list of applications that rely on them. It touches a very large number of fields and some of the most critical systems in each one of them. It works on the basic premise of learning from real world examples or by making decisions in the real world and seeing its outcomes. While these systems can be made to work well, they require a large amount of complex work in addition to building the actual machine learning system in order to make its results consumable as part of a larger product/system that is being built.

In particular, modern machine learning operates in a model where it learns from examples and derives its techniques from non-linear optimization and implicitly performs numerical reasoning. As the field continues to increase its scope of influence, it eventually conflicts with the traditional approach to building computer systems which is based on explicit (e.g., deterministic/predefined) operations/transformations encoded in symbolic logic (e.g., programming language). This conflict has fundamental implications: while machine learning systems can learn very complex functions that map input/output behavior, there isn't much progress in understanding what these functions are and how to tweak them to achieve specific behaviors required by domain knowledge/environment constraints.

Symbolic logic, on the other hand, offers full control and understandability but puts the onus of building the function entirely on the programmer resulting in systems built on layers of heuristics. In particular, by today's state-of-the-art practices, large computer/computational systems are built with symbolic logic which often corresponds to a pre-specified handwritten set of instructions that direct the flow of data and control through them. This allows programmers to precisely control both the mechanics of computation and its outcome. These systems are also understandable as the operations are expressed with explicit symbols. The aspect of complete control allows system developers to express domain constraints and environment restrictions explicitly. However, the same control becomes a drawback since it's impossible to optimize for all the cases in a limited set of handwritten instructions.

Thus, the fields of machine learning and traditional symbolic-logic-based computer programming present a dichotomy of approaches, where each approach has respective limitations and benefits. One proposed solution to this dichotomy is to build machine learning systems that generate code that can be later edited by programmers. However, this puts too much burden on the machine learning systems, as they need to learn the basic semantics of programming and code structure before they can even begin to produce anything useful, and issues of human readability of machine code also come to light.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes obtaining, by one or more computing devices, a computer program that includes a set of computer-executable instructions. The computer program defines a variable that serves as a placeholder for storing data. The method includes providing, by the one or more computing devices, observation data to a machine learning system. The method includes receiving, by the one or more computing devices, a predicted value for the variable produced by the machine learning system based at least in part on the observation data. The method includes setting, by the one or more computing devices, the variable equal to the predicted value. The method includes, after setting, by the one or more computing devices, the variable equal to the predicted value, executing, by the one or more computing devices, the computer program. Executing the computer program includes implementing at least one instruction of the set of computer-executable instructions that controls an operation of the one or more computing devices based at least in part on the variable.

In this way, various examples described herein apply machine learning techniques for the technical purpose of computer implementation (i.e. implementation on a computer). Various examples described herein enable a safe deployment in critical applications, enabling deployments in which there are fewer errors (e.g., memory leaks and/or other run-time errors). Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing architecture according to example embodiments of the present disclosure.

FIG. 2 depicts plot diagrams of the costs of different example variants of binary search, cumulative regret compared to vanilla binary search, and initial function usage.

FIGS. 3A and 3B depict plot diagrams of results from using an example predicted variable for selecting the number of pivots in Quicksort.

FIG. 4 depicts a graphical diagram of fraction of pivots chosen by an example predicted variable in Quicksort after 5000 episodes.

FIG. 5 depicts a block diagram of an architecture of an example neural networks for TD3 with key embedding network.

FIGS. 6A-D depict plot diagrams of example cache performance for power law access patterns.

FIG. 7A depicts a block diagram of an example computing system according to example embodiments of the present disclosure.

FIG. 7B depicts a block diagram of an example computing device according to example embodiments of the present disclosure.

FIG. 7C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to a new framework that enables the combination of symbolic programming with machine learning, where the programmer maintains control of the overall architecture of the functional mapping and the ability to inject domain knowledge while allowing their program to evolve by learning from examples. In some instances, the framework provided herein can be referred to as “predictive programming.”

In particular, the present disclosure provides a framework that hybridizes symbolic and numerical computation. Concretely this can be expressed as the ability to define variables in a program that are “predicted.” Predicted variables are akin to native variables with some important distinctions, such as, for example, the values of some predicted variables can be determined using machine learning when evaluated.

These variables can bind to a certain context that is either explicitly provided by the programmer or implicitly determined by the underlying machine learning system/engine. This allows the programmer to still dictate the overall flow of the program and maintain control, while out-sourcing certain aspects of decision making to the predicted variables and harness the ability to learn from massive datasets or real world user traffic. It also allows the underlying machine learning system that is going to provide these predictive capabilities to observe the effects of its decisions as part of the complete system, exactly the way it will be used in the field, minimizing the so-called online-offline skew.

Predicted variables include a new interface to machine learning that aims to make machine learning as easy as ‘if’ statements. Predictive variables provide an interface that allows for applying machine learning in domains that have traditionally not been using machine learning, thereby enabling, for example, machine learning to help improve the performance of “traditional” algorithms that rely on a heuristic. Predictive variables can be used to replace and augment existing heuristics in traditional algorithms (such as the LRU heuristic in caches) using a minimal predictive variable-interface.

In particular, as opposed to previous work applying machine learning to algorithm problems, predicted variables have the advantage that they can be used within the existing frameworks and do not require the existing domain knowledge to be replaced. Thus, a developer can use a predicted variable just like any other variable, combine it with heuristics, domain specific knowledge, problem constraints, etc. in ways that are fully under the developer's control. This represents an inversion of control compared to how machine learning systems are usually built: Predicted variables allow machine learning to be tightly integrated into algorithms whereas traditional machine learning systems are instead built around the model.

In some implementations, internally predicted variables can be based on standard reinforcement learning methods. For example, standardized API calls can be used for providing observation data (e.g., descriptive of a current state) to the machine learning system, which can then implement a current policy based on the current state to perform an action (e.g., predict a value for the predicted variable). Further, standardized API calls can be used for providing a reward based on the outcome of the action, which can be used by the machine learning system to optimize or otherwise update the current policy. Thus, reinforcement learning schemes can be used to optimize the policy which predicts the predicted variable.

In some implementations, to learn faster, predicted variables can use the heuristic function which they are replacing as an initial policy or initial function. Thus, a predicted variable can replace an existing heuristic and the existing heuristic can be used as the initial function for the predicted variable. This allows the predicted variable to minimize regret in critical applications and allow for safe deployment. In fact, experimental results included further herein show that predicted variables quickly pick up the behavior of the initial policy and then improve performance beyond that without ever performing substantially worse—allowing for a safe live deployment in critical applications. Thus, using an initial function can help to make the machine learning more stable and/or robust and/or can enable the system to provide guarantees that performance is only ever-worse than the heuristic.

The concepts described here can be implemented in almost all programming languages, and in most cases can be done without any work on the language itself (although incorporating the concepts described herein in the language itself could make the learning system more powerful). For example, this may take the form of an add-on library that provides the layer of predictiveness. To illustrate certain examples, a simplified programming language that looks more like pseudo code is used in order to keep focus on the main concepts.

While the next few sections describe predicted variables assuming that they are deterministic, stochastic variables will be covered in subsequent sections.

Thus, the present disclosure provides predicted variables, an approach to making machine learning a first class citizen in programming languages, rendering machine learning in programming as easy as ‘if’ statements. In the sections which follow, the feasibility of the approach is demonstrated on three algorithmic problems: Binary search, Quicksort, and Caches, by enriching and replacing commonly used heuristics with predicted variables. Experimental results are provided that show that predicted variables are able to improve over the commonly used heuristics and lead to a better performance than the algorithms traditionally have.

### Introduction to Software Development with Predicted Variables

Predicted variables aim to make using machine learning in software development easier by avoiding the overhead of going through the full machine learning development workflow of (1) collecting and preparing training data, (2) defining a training loss, (3) training an initial model, (4) tweaking and optimizing the model, (5) integrating the model into their product, and (6) continuously updating and improving the model to adjust for drift in the distribution of the data processed. Predicted variables can provide a simple API that allows the developer to read from it, supply it with enough information about its context, and provide feedback about the consequences of its decisions.

In some implementations, to create a predicted variable, the developer can choose its output datatype (e.g., float, int, category, . . . ), shape, and the desired output range, define which observation the predicted variable is able to observe, and optionally pass in an initial policy. In the following example a float predicted variable is instantiated taking on scalar values between 0 and 1, which can observe three scalar floats, and which uses a simple (constant) initial policy:

```
pvar = Pvar(
    output_def=(float,shape=[1],range=[0,1]),
    observation_defs={‘low’:(float,[1],[0,10]),
                  ‘high’:(float,[1],[0,10]),
                  ‘target’:(float,[1],[0,101)},
    initial_policy=lambda observations: 0.5)
```

One idea is that predicted variables can be used like usual variables, but the developer does not need to assign a value to it. Instead a predicted variable determines its value at read time using inference in an underlying machine learning model, which the developer triggers by calling Predict ( ):

value=pvar.Predict( )

This behavior makes it possible to use predicted variables as a natural part of any program. Specifically, the developer can just use a predicted variable instead of any heuristic or an arbitrarily chosen constant. Predicted variables can also take the form of a stochastic variable, shielding the developer from the underlying complexity of inference, sampling, and explore/exploit strategies.

The predicted variable can determine its value using observations about the context that the developer passes in:

pvar.Observe(‘low’, 0.12)
pvar.Observe({‘high’: 0.56, ‘target’: 0.43})

In some instances, a developer might also provide additional side-information into the predicted variable that an engineered heuristic would not be using but which a powerful model is able to use in order to improve performance.

The developer can provide feedback about the quality of previous predictions once this information becomes available. In this example numerical feedback is provided:

pvar.Feedback(reward=10)

Some implementations of the framework can follow common reinforcement learning practice: a predicted variable aims to maximize the sum of reward values received over time (possibly discounted). In other implementations, the computer program or associated systems might become aware of the correct value in hindsight and provide the “ground truth” answer as feedback, turning the learning task into a supervised learning problem. Some problems might have multiple metrics to optimize for (e.g., run time, memory, network bandwidth) and the developer might want to give feedback for each dimension. Other machine learning techniques can be additionally or alternatively incorporated as well, including, as examples, bandit techniques (e.g., multi-armed bandit), black box optimization, and evolutionary strategies.

In addition to the API calls described above, the developer can specify the models used by a predicted variable using additional configuration parameters. For example, model hyperparameters can be specified and can be tuned independently. The definition of the predicted variable typically only determines its interface (e.g., the types and shapes of inputs and outputs).

This API allows for integrating predicted variables easily and transparently into existing applications with little development overhead.

### Example Predicted Variables

Variables are part of most programming languages and act as placeholders for storing data (and most often data that changes over time). In certain languages one can think of variables and functions interchangeably. While the framework is presented here in terms of predicted variables, they can also be thought of as predicted functions or predicted classes instead.

Variables capture results of key computation and are most often also the basis for control decisions on which set of instructions will be executed next. However, the computation required to get the desired result is often not clear and is rather specified by heuristic rules thought of by a programmer. Examples include determinations regarding: whether a user would like a red themed UI or a blue themed one, which support technology to route this question to; or estimating an amount of time that this job will take to run, so that it can be scheduled accordingly. By making variables predicted, the programmer is given an abstraction where they can hand off parts of this control flow to a learning system.

Let's take a simple example of this, a Hello World program in predictive programming:

```
Predicted Bool decision;
While decision is false
    Print “Still need to improve the predictor”
    feedback(decision, BAD)
End
If decision is true
    Print “Hello World”
End
```

The above example also includes the concept of feedback. Feedback comes from some measure of goodness of the decisions/predictions made by the predicted variables. Every place where the variable is evaluated, for example, in the If statement above, amounts to an evaluation of the variable and affects something in the context of the program. Feedback allows us to connect real world outcomes of this back to the variables that caused them. If the above program is run the output should be:

Still need to improve the predictor <may be printed multiple
times if the initial decision is false>
Hello World

In the hello world program, the constant BAD is just a symbol for negative feedback, it could be defined as any negative number.

Another characteristic of the hello world program is that its predicted variable does not depend on anything, once it has learned a value, it will stay that way. In other words, there is a predicted constant. Its value does not change after the feedback has been fully absorbed.

In many cases, however, a developer will want to write predictors that are not constant, that is, they depend on some context. To express the semantics of expressing context to a prediction, the concept of observations can be used. That is, a predicted variable can be made to observe other variables (to begin with non-predicted, case of predicted covered later).

One example is as follows:

```
// Inside a map navigation context. GPS isn't precise enough
to tell us if we are on a freeway or the road next to it.
Float current_vehicle_speed;
Predicted Bool on_freeway;
on_freeway.observes(current_vehicle_speed)
If on_freeway
    Remove ambiguity about my current vehicle position being
on a road next to freeway.
Else
    I am on the road next to the freeway and not on the
freeway.
End
Take appropriate routing action.
// Later we realize if the vehicle was actually on the freeway
or not after the vehicle has driven further along.
If we find vehicle on freeway at a later point
    feedback(on_freeway, GOOD)
Else
    feedback(on_freeway, BAD)
End
```

Here the variable on_freeway depends on the current speed of the vehicle and hence observes its values. Every time on_freeway is evaluated, its value can depend on the values of the variables it is allowed to observe. To allow on_freeway to be more optimal in its evaluation, it can be allowed to observe more variables in the environment, such as, for example, the geographic location, current traffic, etc. This basic syntax allows us to extend the span of observation by easily adding other factors in our context.

Predicted variables can take on types just like any other and the range of types available will span from basic types to complex/derived ones. In some cases, the basic types can be modified in ways that apply better to this context, e.g., in addition or alternatively to a float type, the predicted variable might also be an nfloat or normalized float type that has values in (0,1).

Some example basic types of predicted variables include: bool, enum, short int, float. Some example modified types of predicted variables include: nfloat (normalized float range (0,1)), r_int (range int, take a range (1,n)) Sequence types: string, vec, list on basic or modified types etc. Some example complex types include: struct (compositions of above types).

### Example Predicted Variables and Persistence

The initial examples of predicted variables made the variables exist only in context of a running program. Now the framework is extended to allow a global namespace for them and allowing persistence across runs. To do so, each predicted variable can have global name.

One example is as follows:

```
// The problem we are solving is making a bunch of UI
decisions that depend on the user. UX teams have identified 3
types of users, those who spend a lot of time exploring the
content of the page, those who only give it a quick glance
before taking action and those in between.
Float user_click_rate; // let's assume this is already
computed
Uint64 user_id;
// Declare first predicted variable
Predicted enum ui_choice {explorers, moderate, single_glance}
ui_choice.set_global_name(“Watch Page UI Choice”)
// add context it can observe
ui_choice.observes(user_click_rate)
ui_choice.observes(user_id)
Case based on ui_choice
    Case explorer
        Show UI “experimental explorers”
    Case single_glance
        Show UI “single glance readers”
    Else
        Show UI “moderate explorers”
End
Compute engagement // based on how users reacted to the UI
feedback(ui_choice, engagement)
```

The ui_choice variable here was given a global name giving it persistence. This means that any number of programs using this variable are actually using one copy of the variable (e.g., its predictor). It is indeed one underlying model, having a unified namespace and feedback statements implies that the model can be trained in a distributed manner and that it could be trained in one setting and adapted in another (possibly with live traffic).

Note that the concept of global name above can also be extended to include a group name. For example, variables used together in a certain context could become part of one group, allowing them to share observables and transfer learning across each other for optimal joint outcomes. It can be accomplished by creating a prediction group and adding variables as members to it.

These groups can have two purposes:

First, they make it easier for the developer to pass feedback to a number of variables at the same time making the process of giving the right feedback to all variables involved less error prone.

Second, they allow for the model to learn about the relationships between variables in the group explicitly. Each variable in a group could also observe all other variables in the group which might enable them to learn “invalid” combinations. In the example above, a certain choice might make some assignments for other variables useless (e.g., the single_glance mode might not have a variable controlling the number of alternatives that are shown in the explorers mode).

One example is as follows:

// Declare a prediction group
PredictionGroup ui_vars
ui_vars.(“Watch Page UI Vars”) // global name for the group.
// Declare first predicted variable
Predicted enum ui_choice {explorers, moderate, single_glance}
ui_choice.set_global_name(“Watch Page UI Choice”)
// Set ui_choice as part of the ui_vars group
ui_vars.add_variable(ui_choice)
// add context it can observe
ui_choice.observes(user_click_rate)
ui_choice.observes(user_id)
// Add other ui variables to the group e.g., font_size,
thumbnail size etc. Use the variables to draw the UI
Compute engagement // based on how user reacted to the UI
// Now give feedback to the whole group
feedback(ui_vars, engagement)

### Initial Functions in Predicted Variables

To start adopting predicted variables it may be helpful to allow for providing an initialization value (or function) that can be used as a default value before a good value was learnt.

One application area for predicted variables is to replace heuristics in existing code. In many cases, these heuristics will have served a purpose for an extended period of time and there will be a certain resistance to “just replace it with a machine learning solution”.

One starting point in many cases will thus likely be to keep serving with the old solution while starting to learn a good model for the predictive variable.

As such, in some implementations, the developer can be enabled to pass an initial function to the predicted variable. In many cases the initial function will be the heuristic that the predicted variable is replacing. Ideally it is a reasonable guess at what values would be good for the predicted variable to return. The predicted variable can use this initial function to avoid very bad performance in the initial predictions and observe the behavior of the initial function to guide its own learning process, similar to imitation learning. However, in contrast to imitation learning where an agent tries to become as good as the expert, predicted variables explicitly aim to outperform the initial function as quickly as possible

The existence of the initial function should strictly improve the performance of a predicted variable. In the worst case, the predicted variable could choose to ignore it completely, but ideally it will allow the predicted variable to explore solutions which are not easily reachable from a random starting point.

In particular, having an initial policy will help a predicted variable in three different ways: i) using it in initial steps will help limiting the regret before the predicted variable has learned an effective model; ii) providing relevant training experience for our off-policy training algorithms. Under the assumption that the initial policy performs reasonably well, it is expected to generate better training data than a purely random policy; iii) as a safety net. In case the predicted variable fails to learn a good policy, the initial policy can be used mitigate very high regrets.

In some implementations, the predictive variable can also allow for monitoring the change compared to the original values and it will ideally allow for measuring the change from experimenting with the predictive variable compared to the original heuristics. The predictive variable could export metrics that allows for easy dashboarding of the obtained feedback for the two modes: default value and predicted value.

In some implementations, for a predicted variable to make use of the initial heuristic, and to balance between learning a good policy and the safety of the initial function, it relies on a policy selection strategy. This strategy switches between exploiting the learned policy, exploring alternative values, and using the initial function. It can be applied at the action or episode level depending on the requirements. The policy selection can compare observed cumulative rewards to decide which policy to execute among random exploration, initial policy, and learned policy and in which ratios.

As one example, in some implementations, at the beginning, only the initial policy is used, only a small amount of exploration is allowed. The initial policy rewards can be accumulated to estimate its performance. After a number of steps (e.g., a fixed number), the learned policy can be used with a small percentage. If the cumulative reward of the learned policy is far worse than the initial policy, it is disabled again and only re-tested later. However, if the learned policy performs at least as well as the initial policy, then its use is increased until the initial policy can be phased out entirely.

### Example Solution Strategies

Given the above framework, this section now describes some potential solution strategies. First, note that the way the framework is outlined, it ensures that proper bookkeeping/logging is possible for a wide range of approaches without relying on a specific solver. In some implementations, every time a variable is evaluated, the control flow falls in the Predictive Programming stack, allowing us to look at the state of all the variables that are being observed and the current state of the variable deduced from the observed variables. This information can be used for bookkeeping or logging so that when feedback is later received, the credit for feedback can be traced back to all the predictions made up to that point and a specific learning signal can be generated to improve the model for evaluating the variable given the observed context.

The above framework for logging also abstracts out another important factor in building machine learning systems today. In some implementations of predictive programming the logging is handled entirely by the system, while that could be specialized by power users, for the average programmer, they don't need to think about the notion of what to log in order to train a machine learning system, instead they only express their intents through predictive variables and the rest is handled for them.

If the underlying programming language is treated as a black box, there are still plausible solution strategies. Some example solutions are outlined below based on the type of problem. The solution used can be specified by a user or a programmer.

Predicted constants: Operations research, black box optimization, reinforcement learning.

Single use variables: bandit solvers, black box optimization, reinforcement learning and supervised learning (in case of explicit truth signal, discussed later).

Sequential decision making: black box optimization such as, for example, evolutionary strategies, reinforcement learning.

Even if it's not explicitly stated, sample runs can provide information regarding which of the above categories the variable belongs to and a solver of appropriate complexity/efficiency can be brought into play for it.

Thus, some implementations of the present disclosure leverage the recent progress in deep reinforcement learning to enable predicted variables, because it will allow for applying predicted variables to the most general use cases. Aspects of the interfaces described herein do naturally translate to reinforcement learning where the input to Observe-calls are observations that are combined into the state, the output of the Predict-call is the action, and feedback is translated into rewards. However, predicted variables can definitely be used with other learning methods such as supervised learning methods or bandit-based methods.

About the special case of supervised learning, for problems where some truth value is available in hind sight, such as, for example, clicks in user interaction prediction, or actual system performance in system optimization etc. This information may be available in a place that is not part of the same program context. This extra information can be passed in the feedback as:

Predicted float predicted_variable
predicted_variable.set_global_name(“global name of this
variable”).
predicted_variable.set_instance_id(instance_id_from_logs)
// Predicted variables can log an instance id for every
prediction they make, it can be accessed in the logs and used
to provide feedback at any specific point in time or to a
specific instance.
feedback( predicted_variable, feedback_value, TRUTH)

which would lead the system to realize that it has a complete supervision signal here and can bring those solvers into effect.

### Example Variables that are Stochastic Under the Hood

So far, the predicted variables have been described as if they are always deterministic. But even deterministic quantities being predicted or estimated always have some uncertainty around them, with the degree of uncertainty being influenced by the amount and quality of data, constraints and prior knowledge, etc. Moreover, some quantities may be best modeled as explicitly random, for example a specific decision to be made by an individual user, or whether snow chains will be required by the time the car reaches the mountains. For both of these reasons, predicted variables can be treated in the background as fundamentally random quantities. In common cases this randomness need not be exposed fully to the user, e.g., when a simple numerical estimate is required for use in an algorithm. This keeps the interface clean and does not require the programmer to think through handling of stochasticity. In other cases (e.g., for power users), error bars around the estimate, or even a full posterior predictive probability distribution may be needed. The proposed framework allows for this access, as well as for expressing constraints or prior knowledge in probabilistic terms when useful to do so. Thus, predicted variables can go into domains like randomized algorithms, belief/variance-based optimization etc., thereby keeping a simple interface to the programmer in many use cases, while providing full control under-the-hood when needed.

### Example Applications of Predicted Variables in Algorithms

This section describes how predicted variables can be used in three different algorithmic problems and how a developer can leverage the power of machine learning easily with just a few lines of code. Experimental results are provided that show how using predicted variables helps improving the algorithm performance.

The example interfaces described above naturally translate into a reinforcement learning setting: the inputs to Observe-calls can be combined into the state, the output of the Predict call can be the action, and Feedback can be the reward.

To evaluate the impact of predicted variables, cumulative regret was measured over training episodes. Regret measures how much worse (or better when it is negative) a method performs compared to another method. Cumulative regret captures whether a method is better than another method over all previous decisions. For some practical use cases we are interested in two properties: (1) Regret should never be very high to guarantee acceptable performance of the predicted variable under all circumstances. (2) Cumulative regret should become permanently negative as early as possible. This corresponds to the desire to have better performance than the baseline model as soon as possible.

Unlike the usual setting which distinguishes a training and evaluation mode, evaluation is performed from the point of view of the developer without this distinction. The developer just plugs in the predicted variable and starts running the program as usual. Due to the online learning setup in which predicted variables are operating, overfitting does not pose a concern. The (cumulative) regret numbers thus do contain potential performance regressions due to exploration noise. This effect could be mitigated by performing only a fraction of the runs with exploration.

For the feasibility study, the computational costs of inference in the model are not accounted for. Predicted variables would be applicable to a wide variety of problems even if these costs were high.

### Example Experimental Setup

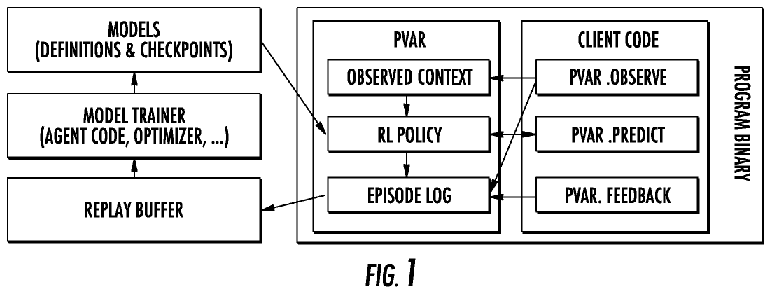

FIG. 1 provides a block diagram of the example architecture used for the experiments described herein. FIG. 1 illustrates how client code communicates with a predicted variable and how the model for the predicted variable is trained and updated via a machine learning system. The program binary includes a small library (illustrated in FIG. 1 as “PVar”) that exposes the predicted variable interface to client applications. A predicted variable assembles observations, actions, and feedback into episode logs that are passed to a replay buffer. The models are trained asynchronously. When a new checkpoint becomes available the predicted variable loads it for use in consecutive steps.

To enable predicted variables, recent progress in reinforcement learning was leveraged for modelling and training. It allows application of predicted variables to the most general use cases.

The example experimental models were built on DDQN (Hasselt et al. 2016) for categorical outputs and on TD3 (Fujimoto et al. 2018) for continuous outputs. DDQN is a de facto standard in reinforcement learning since its success in AlphaGo. TD3 is a recent modification to DDPG (Lillicrap et al. 2015) using a second critic network to avoid overestimating the expected reward.

Table 1 immediately below provides parameters for the different experiments described below (FC=fully connected layer, LR=learning rate).

| | Binary | | Caches | Caches |
|---|---|---|---|---|
| | search | Quicksort | (discrete) | (continuous) |
| Learning | TD3 | DDQN | DDQN | TD3 |
| algorithm | | | | |
| Actor network | FC₁₆ | — | — | FC₁₀ → tanh |
| | → tanh | | | |
| Critic/value | FC₁₆ | (FC₁₆, ReLU)² | (FC₁₀, ReLU)² | FC₁₀ |
| network | | → FC | → FC | |
| Key embedding | — | — | 8 | |
| size | | | | |
| Discount | 0.8, 0 | 0 | 0.8 | |
| LR actor | 10⁻³ | — | — | 10⁻⁴ |
| Initial function | yes | no | | |
| decay | | | | |
| Batch size | 256 | | 1024 | |
| Action noise σ | 0.03 | — | — | 0.01 |
| Target noise σ | 0.2 | — | — | 0.01 |

| | | | |
|---|---|---|---|
| Temperature | — | 0.1 | — |

| | | |
|---|---|---|
| Update ratio (τ) | 0.05 | 0.001 |

Common: Optimizer: Adam; LR critic: 10⁻⁴; Replay buffer: Uniform, FIFO, size 20000; Update period: 1.

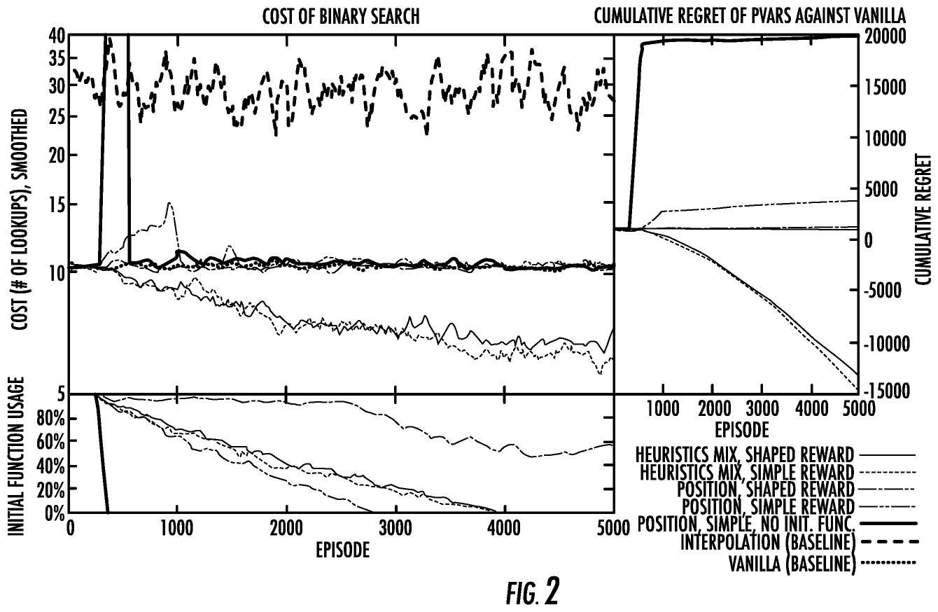

The example policy selection strategy used in the experiments starts by only evaluating the initial function and then gradually starts to increase the use of the learned policy. It keeps track of the received rewards of these policies adjusts the use of the learned policy depending on its performance. The usage rate of the initial function when it is used is shown in the bottom pane of FIG. 2, demonstrating the effectiveness of this strategy.

Similar to many works that build on reinforcement learning technology, the experiments described herein are faced with the reproducibility issues described by Henderson et al. 2018. Among multiple runs of any experiment, only some runs exhibit the desired behavior, which are reported. However, in the “failing” runs baseline performance is observed because the initial function acts as a safety net. Thus, the experiments show that the proposed system can outperform the baseline heuristics without a high risk to fail badly.

### Example Application to Binary Search

Binary search (Williams 1976) is a standard algorithm for finding the location lₓ of a target value x in a sorted array A={a₀, a₁, . . . , a_{N-1}} of size N. Binary search has a worst-case runtime complexity of [log₂(N)] steps when no further knowledge about the distribution of data is available. Knowing more about the distribution of the data can help to reduce expected runtime. For example, if the array values follow a uniform distribution, the location of x can be approximated using linear interpolation lₓ≈(N−1)(x−a₀)/(a_{N-1}−a₀). We show how predicted variables can be used to speed up binary search by learning to estimate the position lₓ for a more general case.

The simplest way of using a predicted variable is to directly estimate the location lₓ and incentivize the search to do so in as few steps as possible by penalizing each step by the same negative reward (see, e.g., listing 1 provided below). At each step, the predicted variable observes the values a_{L}, a_{R} at both ends of the search interval and the target x. The predicted variable output q is used as the relative position of the next read index m, such that m=qL+(1−q)R.

Listing 1 (standard binary search on top and a simple way to use a predicted variable in binary search at bottom):

1 def bsearch(x, a, l=0, r=len(a)−1:
2 if l > r: return None
3
4
5 q = 0.5
6 m = int(q*l + (1−q)*r)
7 if a[m] == x:
8 return m
9
10 if a[m] < x:
11 return bsearch(x, a, m+1, r)
12 return bsearch(x, a, l, m−1)
1 def bsearch(x, a, l=0, r=len(a)−1:
2 if l > r: return None
3 pvar.Observe({‘target’:x,
4 ‘low’:a[l], ‘high’:a[r]})
5 q = pvar.Predict( )
6 m = int(q*l + (1−q)*r)
7 if a[m] == x:
8 return m
9 pvar.Feedback(−1)
10 if a[m] < x:
11 return bsearch(x, a, m+1, r)
12 return bsearch(x, a, l, m−1)

In order to give a stronger learning signal to the model, the developer can incorporate problem-specific knowledge into the reward function or into how the predicted variable is used. One way to shape the reward is to account for problem reduction. For binary search, reducing the size of the remaining search space will speed up the search proportionally and should be rewarded accordingly. By replacing the step-counting reward in listing 1 (line 9) with the search range reduction (Rₜ−Lₜ)/(Rₜ₊₁−Lₜ₊₁), we directly reward reducing the size of the search space. By shaping the reward like this, we are able to attribute the feedback signal to the current prediction and to reduce the problem from reinforcement learning to contextual bandit (which we implement by using a discount factor of 0).

Alternatively, we can change the way the prediction is used to cast the problem in a way that the predicted variable learns faster and is unable to predict very bad values. For many algorithms (including binary search) it is possible to predict a combination of (or choice among) several existing heuristics rather than predicting the value directly. We use two heuristics: (a) vanilla binary search which splits the search range {a_{L}, a_{R}} into two equally large parts using the split location l^{v}=(L+R)/2, and (b) interpolation search which interpolates the split location as lⁱ=((a_{R}−v)L+(v−a_{L})R)/(a_{R}−a_{L}). We then use the value q of the predicted variable to mix between these heuristics to get the predicted split position l^{q}=ql^{v}+(1−q)lⁱ. Since in practice both of these heuristics work well on many distributions, any point in between will also work well. This reduces the risk for the predicted variable to pick a value that is really bad which in turn helps learning. A disadvantage is that it's impossible to find the optimal strategy with values outside of the interval between l^{v} and lⁱ.

To evaluate the proposed approaches, a test environment was used where, in each episode, we sample an array of 5000 elements from a randomly chosen distribution (uniform, triangular, normal, pareto, power, gamma and chisquare), sort it, scale to [−10⁴,10⁴] and search for a random element.

FIG. 2 shows the cost of different variants of binary search (top left), cumulative regret compared to vanilla binary search (right), and initial function usage (bottom). In particular, FIG. 2 shows the results for the different variants of binary search using a predicted variable and compares them to the vanilla binary search baseline. The results show that the simplest case (position, simple, no initial function) where we directly predict the relative position with the simple reward and without using an initial function performs poorly initially but then becomes nearly as good as the baseline (cumulative regret becomes nearly constant after an initial bad period). The next case (position, simple reward) has an identical setup but we are using the initial function and we see that the initial regret is substantially smaller. By using the shaped reward (position, shaped reward), the predicted variable is able to learn the behavior of the baseline quickly. Both approaches that are mixing the heuristics significantly outperform the baselines.

TABLE 2
Training episodes required for the cumulative regret to become
permanently negative (compared to all baselines)
for all combinations of Prediction, Reward, and use
of initial functions (“—”: does not happen within 5000 episodes).

| Prediction | Position | | | | Heuristics Mix | | | |
|---|---|---|---|---|---|---|---|---|
| Reward | simple | | shaped | | simple | | shaped | |
| Initial function | no | yes | no | yes | no | yes | no | yes |
| Random | — | — | — | — | 1058 | — | 425 | 258 |
| Chisquare | — | — | 3231 | 4885 | 3937 | 285 | 409 | 240 |
| Gamma | — | — | 3218 | — | — | 248 | 594 | — |
| Normal | — | — | 3396 | — | 1048 | 283 | 403 | 252 |
| Pareto | — | — | 4255 | 4586 | — | 398 | 508 | 256 |
| Power | — | — | — | — | 1053 | — | 1234 | 234 |
| Triangular | — | — | — | — | 519 | 2618 | 666 | 2291 |
| Uniform | — | — | — | — | — | — | — | — |

Table 2 immediately above compares the different variants of using a predicted variable in binary search with respect to when they reach break-even. The numbers indicate how many episodes it takes for the cumulative regret to become permanently negative, which means that for any additional evaluations after that point the user has a net benefit from using a predicted variable compared to not using ML at all. The table shows that reward shaping and using the predictions smartly improve performance, but it also shows that even simple methods are able to give improvements. Note that no model outperforms interpolation search on a uniform distribution as it is the best approximation for this distribution.

### Example Quicksort Application

Quicksort (Hoare 1962) sorts an array in-place by partitioning it into two sets (smaller/larger than the pivot) recursively until the array is fully sorted. Quicksort is one of the most commonly used sorting algorithms where many heuristics have been proposed to choose the pivot element. While the average time complexity of Quicksort is θ(N log(N)), a worst-case time complexity of O(N²) can happen when the pivot elements are badly chosen. The optimal choice for a pivot is the median of the range, which splits it into two parts of equal size.

To improve Quicksort using a predicted variable, one example approach aims at tuning the pivot selection heuristic. To allow for sorting arbitrary types, we decided to use the predicted variable to determine the number of elements that are sampled from the array to be sorted and then pick the median from these samples as the pivot (see, e.g., listing 2).

In particular, listing 2 provides a Quicksort implementation that uses a predicted variable to choose the number of samples to compute the next pivot. As feedback, we use the cost of the step compared to the optimal partitioning.

Listing 2:

1 def qsort(a, l=0, r=len(a)):
2 if r <= l+1:
3 return
4 m = pivot(a, l, r)
5 qsort(a, l, m−1)
6 qsort(a, m+1, r)
7
8 def delta_cost(c_pivot, n, a, b):
9 #See eq. 1
1 def pivot(a, l, r):
2 pvar.Observe({‘left’:l, ‘right’:r})
3 q = min(1+2*pvar.Predict( ), r−l)
4 v = median(sample(a[l:r], q))
5 m = partition(a, l, r, v)
6 c = cost_of_median_and_partition( )
7 d = delta_cost(c, r−l, m−l, r−m)
8 pvar.Feedback(1/d)
9 return m

As feedback signal for a recursion step, an estimate of its impact on the computational cost Δc can be used:

$$Δ c = \frac{{c}_{pivot} + Δ {c}_{r e c u r s i v e}}{{c}_{e x p e c t e d}} = \frac{{c}_{pivot} + ( a log a + b log b - 2 \frac{n}{2} log \frac{n}{2} )}{n log n} , \qquad ( 1 )$$

where n is the size of the array, a and b are the sizes of the partitions with n=a+b and cₚᵢᵥₒₜ=c_{median}+cₚₐᵣₜᵢₜᵢₒₙ is the cost to compute the median of the samples and to partition the array. Δc_{recursive} takes into account how close the current partition is to the ideal case (median). The cost is a weighted sum of number of reads, writes, and comparisons. Similar to the shaped reward in binary search, this reward allows us to reduce the reinforcement learning problem to a contextual bandit problem and we use a discount of 0.

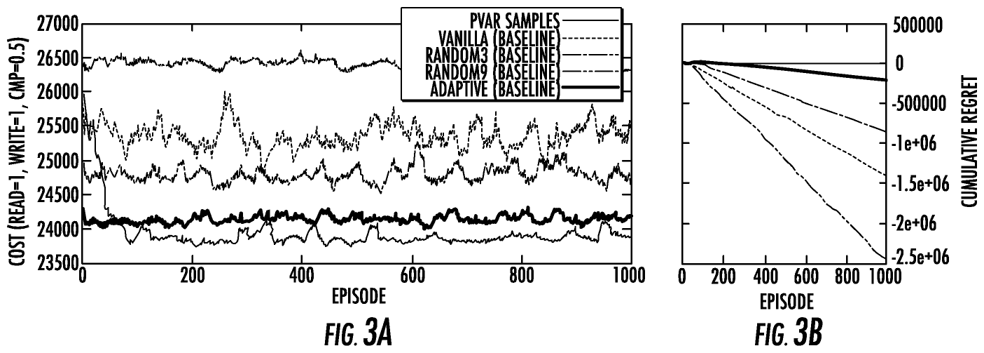

For evaluation we are using a test environment where we sort randomly shuffled arrays. Results of the experiments from using a predicted variable for selecting the number of pivots in Quicksort are presented in FIGS. 3A and 3B. In particular, FIG. 3A shows the overall cost for the different baseline methods and for the variant with a predicted variable over training episodes. FIG. 3B shows the cumulative regret of the predicted variable method compared to each of the baselines over training episodes.

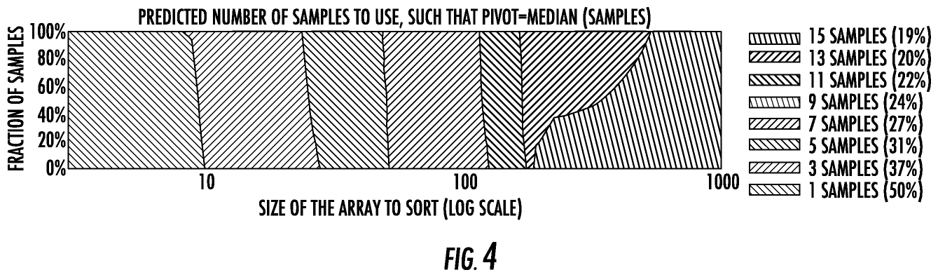

FIG. 4 shows the fraction of pivots chosen by the predicted variable in Quicksort after 5000 episodes. The expected approximation error of the median is given in the legend, next to the number of samples. FIG. 4 shows that the predicted variable learns a non-trivial policy. The predicted variable learns to select more samples at larger array sizes which is similar to the behavior that we hand-coded in the adaptive baseline but in this case no manual heuristic engineering was necessary and a better policy was learned. Also, note that a predicted variable-based method is able to adapt to changing environments which is not the case for engineered heuristics. One surprising result is that the predicted variable prefers 13 over 15 samples at large array sizes. We hypothesize this happens because relatively few examples of large arrays are seen during training (one per episode, while arrays of smaller sizes are seen multiple times per episode).

### Example Caches Application

Caches are a commonly used component to speed up computing systems. They use a cache replacement policy (CRP) to determine which element to evict when the cache is full and a new element needs to be stored. Probably the most popular CRP is the least recently used (LRU) heuristic which evicts the element with the oldest access timestamp. A number of approaches have been proposed to improve cache performance using machine learning. The present disclosure provides two different example approaches to how predicted variables can be used in a CRP to improve cache performance.

Discrete (e.g., listing 3 below): A predicted variable directly predicts which element to evict or chooses not to evict at all (by predicting an invalid index). That is, the predicted variable learns to become a CRP itself. While this is the simplest way to use a predicted variable, it makes it more difficult to learn a CRP better than LRU (in fact, even learning to be on par with LRU is non-trivial in this setting).

Listing 3 (cache replacement policy directly predicting eviction decisions):

1 keys = ... # keys now in cache
2
3 # Returns evicted key or None.
4 def miss(key)
5 pvar.Feedback(−1) # Miss penalty.
6 pvar.Observe(‘access’, key)
7 pvar.Observe(‘memory’, keys)
8 return evict(pvar.Predict( ))
1 def evict(i)
2 if i >= len(keys): return None
3 pvar.Feedback(−1) # Evict penalty.
4 pvar.Observe(‘evict’, keys[i])
5 return keys[i]
6 def hit(key):
7 pvar.Feedback(1) # Hit reward.
8 pvar.Observe(‘access’, key)

Continuous (e.g., listing 4 below): A predicted variable is used to enhance LRU by predicting an offset to the last access timestamp. Here, the predicted variable learns which items to keep in the cache longer and which items to evict sooner. In this case it becomes trivial to be as good as LRU by predicting a zero offset. The predicted variable value in (−1,1) is scaled to get a reasonable value range for the offsets. It is also possible to choose not to store the element by predicting a sufficiently negative score.

Listing 4 (cache replacement policy using a priority queue):

1 q = min_priority_queue(capacity)
2 def priority(key):
3 pvar.Observe(...)
4 score = pvar.Predict( )
5 score *= capacity * scale
6 return time( ) + score
1 def hit(key):
2 pvar.Feedback(1) # Hit reward.
3 q.update(key, priority(key))
4 def miss(key)
5 pvar.Feedback(−1) # Miss penalty.
6 return q.push(key, priority(key))

In both approaches the feedback given to the predicted variable is whether an item was found in the cache (+1) or not (−1). In the discrete approach we also give a reward of −1 if the eviction actually takes place.

In the example implementations the observations are the history of accesses, memory contents, and evicted elements. The predicted variable can observe (1) keys as a categorical input or (2) features of the keys.

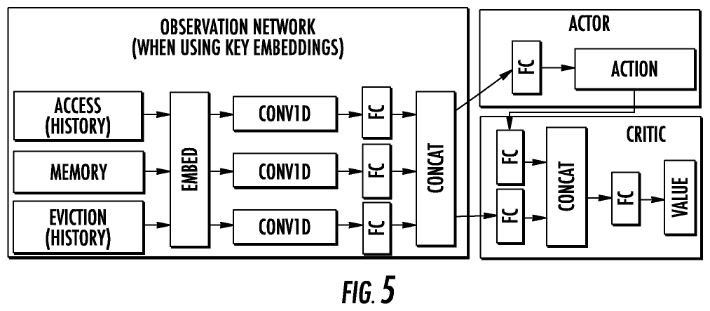

Observing keys as categorical input allows to avoid feature engineering and enables directly learning the properties of particular keys (e.g., which keys are accessed the most) but makes it difficult to deal with rare and unseen keys. To handle keys as input, one example approach is to train an embedding layer shared between the actor and critic networks. In particular, FIG. 5 shows an architecture of example neural networks for TD3 with key embedding network.

As features of the keys we observe historical frequencies computed over a window of fixed size. This approach requires more effort from the developer to implement such features but pays off with better performance and the fact that the model does not rely on particular key values.

Experiments were conducted with three combinations of these options: (1) discrete caches observing keys, (2) continuous caches observing keys, (3) continuous caches observing frequencies. For evaluation a cache with size 10 and integer keys from 1 to 100 was used. Two synthetic access patterns were used of length 1000, sampled i.i.d. from a power law distribution with α=0.1 and α=0.5.

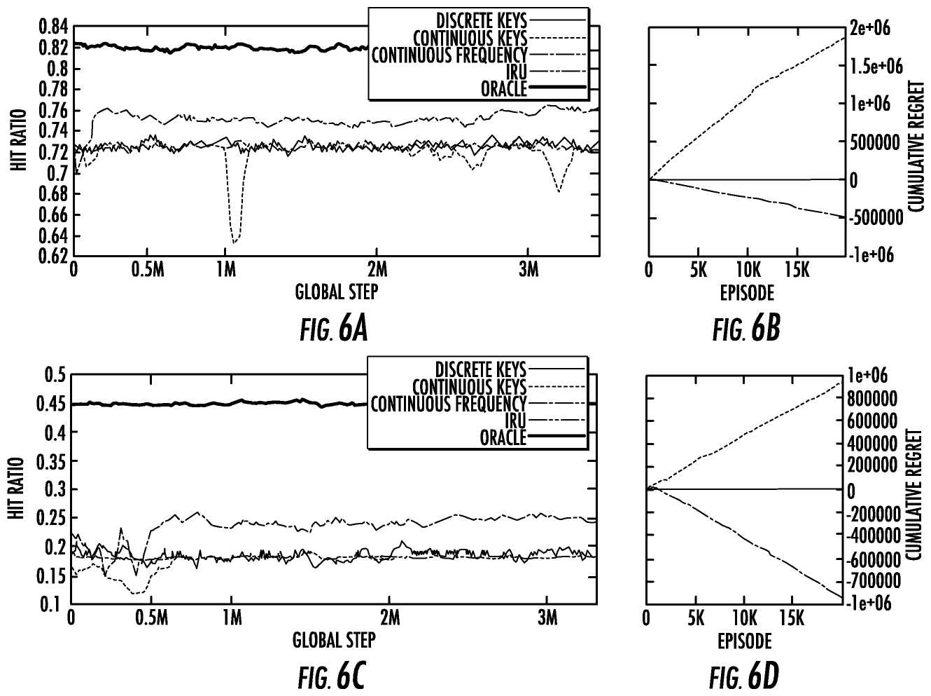

FIGS. 6A-D show results for the three variants of predicted caches, a standard LRU cache, and an oracle cache to give a theoretical, non-achievable, upper bound on the performance. In particular, FIGS. 6A-D show cache performance for power law access patterns. For FIGS. 6A and 6B: α=0.1, while for FIGS. 6C and 6D: α=0.5. FIGS. 6A and 6C show Hit Ratio (w/o exploration) and FIGS. 6B and 6D show Cumulative Regret (with exploration).

We look at the hit ratio without exploration to understand the potential performance of the model once learning has converged. However, cumulative regret is still reported under exploration noise.

Both implementations that work directly on key embeddings learn to behave similar to the LRU baseline without exploration (comparable hit ratio). However, the continuous variant pays a higher penalty for exploration (higher cumulative regret). Note that this means that the continuous variant learned to predict constant offsets (which is trivial), however the discrete implementation actually learned to become an LRU CRP which is non-trivial. The continuous implementation with frequencies quickly outperforms the LRU baseline, making the cost/benefit worthwhile long-term (negative cumulative regret after a few hundred episodes).

### Additional Example Uses

### Example Context Free Prediction Variables e.g., Hello World

Variables that are context free can still learn from the past history of their own evaluations. They can also be stochastic under the hood, so while a variable may be of type Boolean, internally it can maintain more state so as to provide the best Boolean answer whenever evaluated.

Variables that don't observe any context, don't use past history and are not stochastic are equivalent of a constant. The main difference is that this “constant” value is learned by the prediction system to maximize the score received in feedback and that it may be different each time that it is read (if the variable is stochastic under the hood).

Some example problems include:

Learning coefficients of heuristic tuning formulas;

Learning coefficients for approximations;

Determining good threshold values; and

Learning optimal parameters in a configuration.

This category of variables can prove useful in replacing the large number of heuristic formulas and ad-hoc choices that are often made in building a full stack software system with choices that are aware of the downstream effects of the choice (since the variables maximize some end quantity that we care about).

### Example Context Dependent Variables that are Used Only Once

The predicted variables that use context can be further bifurcated to ones that are used exactly once before feedback is received and ones that can be used several times.

Example problems of single user variables include:

Making category decisions;

Inferring attributes of a user;

Probability of transaction being fraud;

How likely will the user like this item;

Smart UI elements such as, for example, UI elements that can adapt themselves to the given context of user, device, geo, content inside it etc.; and

Distributed system configuration for best throughput.

This category covers all the cases where decisions are made and executed in a single shot. There can still be arbitrary domain knowledge and real-world interactions that follow that decision. The reason to separate this case out is to show progressive buildup of complexity needed to implement a system like this behind the scenes.

### Example Sequential Decision Making

Next, a more involved example shows how variables can be invoked repeatedly for making a sequence of decisions. For this take the problem of load balancing. Requests are coming in to an API endpoint, it has to forward it to one of n replicas. The goal is to achieve best possible latency at 90th percentile. (A very practical problem most products deal with). In terms of context, let's assume that the current load of each replica and its average response time for the last 30 requests is known. So, in this simple case, there are two features per replica.

The variable will decide which replica to send this query to and will be invoked repeatedly for each query. Feedback will be the 90th percentile for latency. One example is as follows:

```
// Assume these variables are already containing the relevant
info about replicas
Vector<float> current_load;
Vector<float> avg_response_time;
Predicted r_int chosen_replica(1,n); // a range int taking
value in (1,n) chosen_replica.observes(current_load)
chosen_replica.observes(avg_response_time)
Vector<float> response_time_history
While forever
    Input request R
    Send R to chosen_replica
    Add response time in response_time_history
    Do every 100k points
        resp90 = 90th percentile response time.
        feedback(chosen_replica, −re5p90) // minimize resp
time
        Empty response_time_history
    End
End
```

Here the replica choice variable is invoked repeatedly inside a loop. Each time a decision is made based on that variable and we get feedback on the aggregate consequence of these decisions. In addition, unlike in the previous case, there's no single optimal value for the predicted variable—returning the same value for chosen_replica time-after-time would be problematic in a load balancing system.

This opens up the system for handling a very large class of problems including, as examples:

Combinatorial search and optimization;

Systems optimization like caching, load balancing, scheduling, etc.;

Graph based problems, such as, for example, TSP, Path finding, Navigation, etc.; Market Algorithms, finding optimal parameters for market efficiency; and

As an outer loop to any collection of heuristic or learned strategies, such as, for example, searching/fast indexing, divide and conquer methods etc.

### Example Advanced Usage

Much of the description above was geared towards a programmer that does not have prior knowledge of or deep exposure to machine learning. If the user however had in depth knowledge of ML, this abstraction can still be useful to them while maintaining the clean interface and yet giving them enough (or complete) control over the process.

For every predicted variable we can expose a FullConfig object that has specs and controls for all the different aspects of the machine learning system that is being used under the hood for that variable.

In one example, we want to incorporate local events and weather information in our path finding algorithm for maps navigation:

```
Predicted r_int next_node(1,n)
next_node.observes(current_graph)
next_node.observes(current_path)
next_node.observes(local_events)
next_node.observes(local_weather)
While path not found
    Visit next_node
    Compute goodness measure over the current path.
End
```

Here we intend to train a system to decide which node to visit next in order to get good paths quickly and also take into account other side information like weather, local events etc. The above pseudocode provides a simple abstraction that neatly separates the machine learning components from the overall structure of the program while keeping control in the hands of the programmer.

If the power user then wants to tweak the specifics of the solver, they can do the following:

FullLearningSpec spec = next_node.FullLearningSpec( )
spec.set_learning_rate(0.001)
spec.set_network_depth_for_observer(current_path, [100 20])
spec.set_network_depth_for_observer(current_graph, [1000 200])
spec.set_network_depth_for_observer(local_events, [30 20])
spec.set_network_depth_for_observer(local_weather, [100 20])
spec.set_fusion_level(FullLearningSpec.LateFusion( ))
Etc.

One main benefit of staying within the abstraction for the power users is ease of evolving their system. As one example, if they get one more side band information, they don't need to write lots of Flume jobs and data converters to incorporate them, they just read it in context of their main program and have the variable depend on it. If they want to predict the goodness value of the whole path, they can just add another variable to do it. If they want the next node predictor and the goodness measure to share parameters, they can add both variables in a group, etc.

In further implementations, the framework can provide additional advanced features such as multiple feedback metrics, automatic AB experiments, distributed log aggregation and efficiencies, and/or other features.

### Additional Example Computer Science Problem Applications

The following are example problems that can be solved using the provided framework.

Caches (LRU Cache etc.)

1. What to evict from a cache instead of using an LRU strategy. LRU as a heuristic works well in many cases but is probably not perfect and can fail badly in some cases.

A predictive variable could aim at learning an “oracle” what to evict from the cache.

2. Cache size: Caches are wasteful of memory when they are too large and don't perform well when cache is too small. Determine a good cache size as a predictive variable.

Search Algorithms (A* etc.)

A* uses a heuristic to estimate the remaining costs to guide its search. Learn a good heuristic function as a predictive variable to make A* perform well and remove the need to specify a heuristic manually.

Branch and Bound Algorithms

Use predictive variables to determine a good branch strategy.

Note that Branch and Bound algorithms are often used to approximate NP-hard problems. A good goal here would be to obtain a better approximation using predictive variables.

Divide and Conquer Algorithms

Use predictive variables to determine a good dividing strategy (e.g., compare binary search & quicksort below).

Search Algorithms

Improve binary search where the “binary” split point could be determined by a predictive variable.

Sorting Algorithms

Improve QuickSort by picking a pivot using a predictive variable. This would probably only have an impact in very large sorting problems.

MergeSort: determine branching factor as a predictive variable.

Approximating TSP

General idea: Improve empirical approximation quality by using predictive variables.

Some additional ideas:

Greedy algorithms: nearest neighbor picking: use a predictive variable to compute neighborhood distances—aiming to make that better than using actual nearest neighbors

Pairwise exchange: pick edges to exchange using a predictive variable+pick which edges to insert using a predictive variable

Ant colony optimization: replace ants with little predictive variables;)

Replace Small Heuristics in UX

Lots of apps have small heuristics built in—replace these with predictive variables.

Determine Learning Rate/Step Size in Gradient Descent/Optimizers

Many optimizers only work if you figure out the right learning rate—which can be wildly different among different optimizers. In addition, many optimizers have more than one meta-parameter (beta1, beta2, epsilon in Adam) which are rarely tuned at all. Set these learning rates as predictive variables and improve them over time.

### Example Devices and Systems

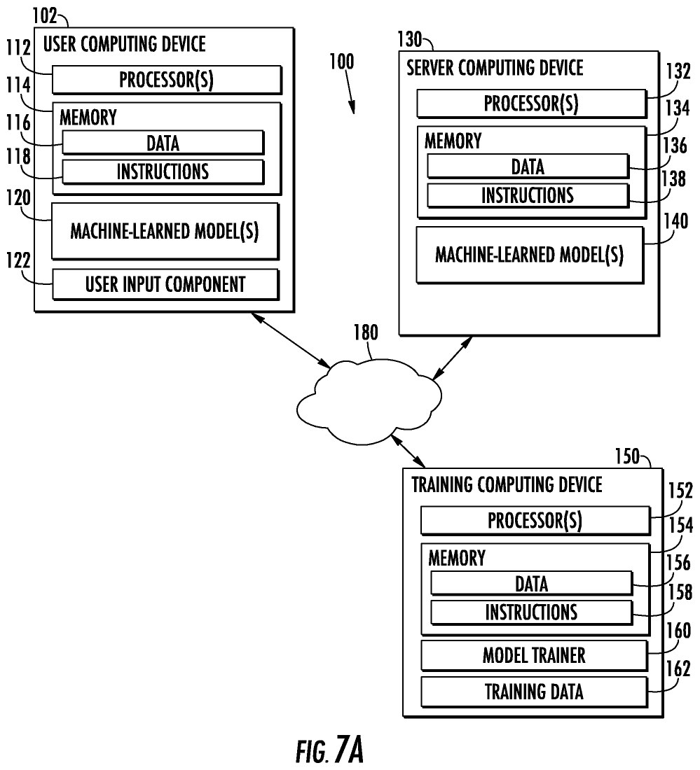

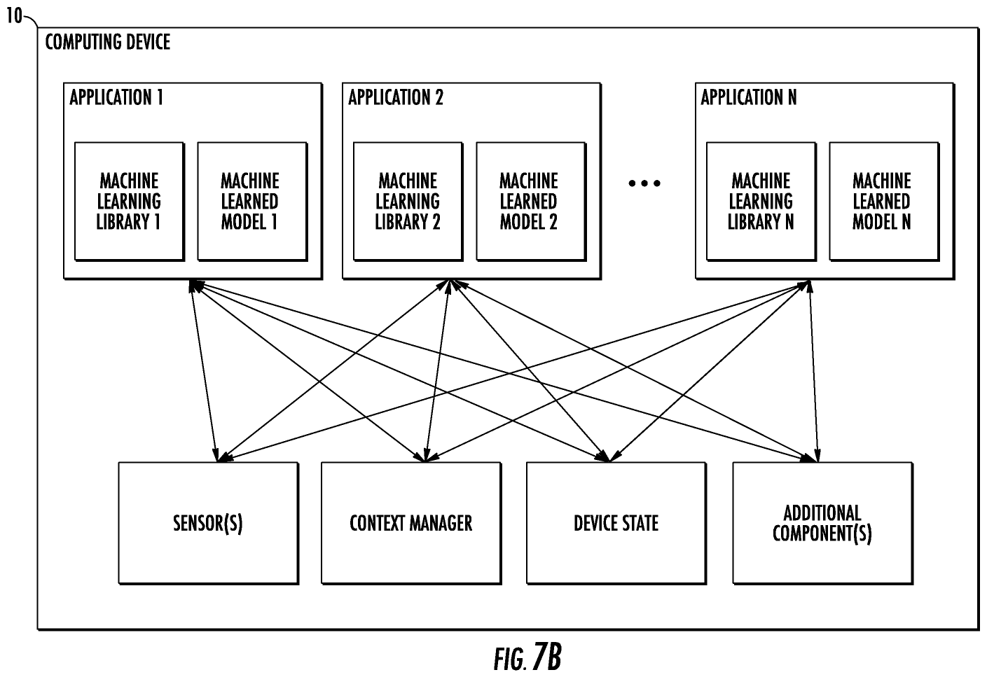

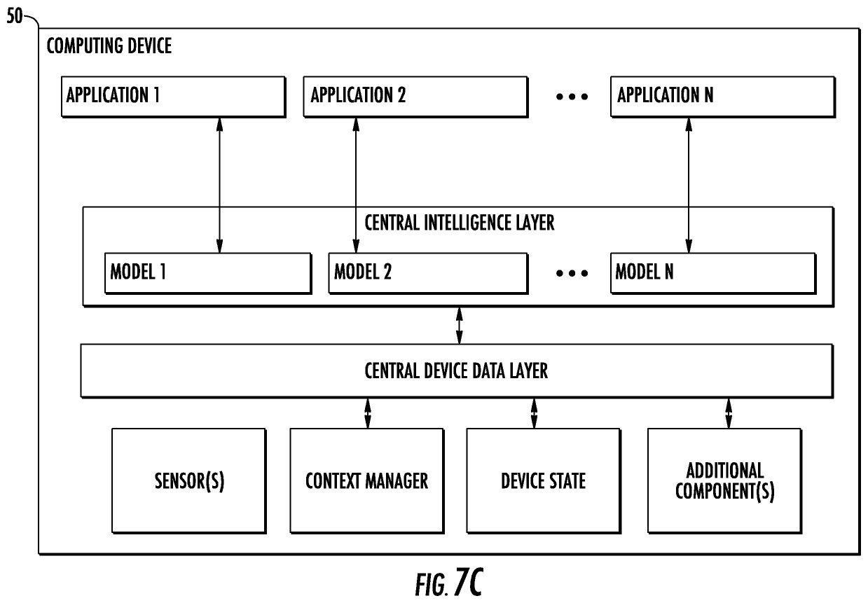

FIG. 7A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single OVERALL model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. In some implementations, performing backwards propagation of errors can include performing truncated backpropagation through time. The model trainer 160 can perform a number of generalization techniques (e.g., weight decays, dropouts, etc.) to improve the generalization capability of the models being trained. In some implementations, the model trainer 160 can perform supervised learning techniques. In some implementations, the model trainer 160 can perform reinforcement learning techniques. In some implementations, the model trainer 160 can perform unsupervised learning techniques. In some implementations, the model trainer 160 can perform black box optimization techniques.

In particular, in some instances, the model trainer 160 can train the machine-learned models 120 and/or 140 based on a set of training data 162. The training data 162 can include, for example, feedback data provided by a computer program.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general-purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 7A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 7B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 7B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 7C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 7C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 7C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method, the method comprising:
obtaining, by one or more computing devices, a computer program that comprises a set of computer-executable instructions, wherein the computer program defines a variable that serves as a placeholder for storing data;
providing, by the one or more computing devices, observation data to a machine learning system;
receiving, by the one or more computing devices, a predicted value for the variable produced by the machine learning system based at least in part on the observation data;
setting, by the one or more computing devices, the variable equal to the predicted value; and
after setting, by the one or more computing devices, the variable equal to the predicted value, executing, by the one or more computing devices, the computer program, wherein executing the computer program comprises implementing at least one instruction of the set of computer-executable instructions that controls an operation of the one or more computing devices based at least in part on the variable.

2. The computer-implemented method of claim 1, wherein receiving, by the one or more computing devices, the predicted value for the variable produced by the machine learning system comprises receiving, by the one or more computing devices via a predefined application programming interface, the predicted value for the variable produced by the machine learning system.

3. The computer-implemented method of claim 1, wherein the machine learning system combines the observation data into a current state, and wherein the variable comprises a stateful variable.

4. The computer-implemented method of claim 1, wherein providing, by the one or more computing devices, the observation data to the machine learning system comprises providing, by the one or more computing devices via a predefined application programming interface, the observation data to the machine learning system.

5. The computer-implemented method of claim 1, wherein said providing, by the one or more computing devices, the observation data to the machine learning system is caused by and a result of execution of at least one instruction included in the computer program.

6. The computer-implemented method of claim 1, wherein the observation data describes a current value of one or more other variables defined by the computer program.

7. The computer-implemented method of claim 1, further comprising:
providing, by the one or more computing devices, feedback data to the machine learning system, wherein the feedback data is used to train the machine learning system to predict the variable.

8. The computer-implemented method of claim 7, wherein providing, by the one or more computing devices, the feedback data to the machine learning system comprises providing, by the one or more computing devices via a predefined application programming interface, the feedback data to the machine learning system.

9. The computer-implemented method of claim 7, wherein said providing, by the one or more computing devices, the feedback data to the machine learning system is caused by and a result of execution of at least one instruction included in the computer program.

10. The computer-implemented method of claim 7, wherein the feedback data describes an outcome of the operation of the one or more computing devices that was controlled based at least in part on the variable.

11. The computer-implemented method claim 7, further comprising:
determining, by the machine learning system, a reward value based at least in part on the feedback data; and
modifying, by the machine learning system based at least in part on the reward value, a policy implemented by the machine learning system to produce the predicted value for the variable.

12. The computer-implemented method of claim 7, wherein the feedback data describes a ground truth value for the variable that was observed after receiving the predicted value for the variable.

13. The computer-implemented method of claim 7, further comprising:
performing, by the machine learning system, supervised learning based at least in part on a loss function that compares the predicted value for the variable paired with the ground truth value for the variable.

14. The computer-implemented method of claim 7, further comprising:
determining, by the machine learning system, a fitness value based at least in part on the feedback data; and
determining, by the machine learning system based at least in part on the fitness value, whether to select a mutated model implemented by the machine learning system to produce the predicted value for the variable or to select to an alternative model.

15. The computer-implemented method of claim 7, wherein providing, by the one or more computing devices, the feedback data to the machine learning system comprises providing, by the one or more computing devices, the feedback data to a prediction group, wherein the prediction group includes the variable and one or more additional variables such that feedback is provided for multiple variables at the same time.

16. The computer-implemented method of claim 1, wherein the machine learning system comprises a software agent that produces the predicted value for the variable or the machine learning system comprises a machine-learned model that produces the predicted value for the variable.

17. (canceled)

18. (canceled)

19. The computer-implemented method of claim 1, wherein the variable comprises one of the following types:
Boolean;
enumeration;
short int;
float;
normalized float;
int within a defined range;
string sequence;
a vector of any of the above;
a vector of vectors;
a list of any of the above; or
a combination thereof.

20. The computer-implemented method of claim 1, wherein the variable exists only within a single running instance of the computer program.

21. The computer-implemented method of claim 1, wherein the variable persists across multiple running instances of the computer program.

22. The computer-implemented method of claim 1, wherein the variable persists across the computer program and one or more additional computer programs.

23. The computer-implemented method of claim 1, wherein the computer program is executed by a first computing device and the machine learning system is executed by a second computing device that is different and distinct from the first computing device.

24. (canceled)

25. (canceled)

26. The computer-implemented method of claim 1, wherein the machine learning system comprises a library that has been added to the computer program.

27. The computer-implemented method of claim 1, wherein the set of computer-executable instructions included in the computer program encode symbolic logic, and wherein the machine learning system performs numerical reasoning to produce the predicted value for the variable.

28. The computer-implemented method of claim 1, wherein an initial policy of the machine learning system comprises a user-defined heuristic.

29-33. (canceled)

34. One or more non-transitory computer-readable media that collectively store instructions that, when executed by one or more processors, cause the one or more processors to:
communicate using an application programming interface that enables a set of client code to interface with a machine learning system to receive a predicted value for a predicted variable defined within the set of client code;
wherein the application programming interface further enables the set of client code to pass observation data to the machine learning system, wherein the machine learning system infers the predicted value for the predicted variable based at least in part on the observation data;
wherein the application programming interface further enables the set of client code to pass feedback data to the machine learning system, wherein the machine learning system uses the feedback data to update a learned inference model that predicts the predicted value for the predicted variable.

35. (canceled)

36. (canceled)

37. The one or more non-transitory computer-readable media of claim 34, wherein the application programming interface is embodied in a library, wherein the library is incorporated into a computer program that also includes the set of client code.
